(19) United States
(12) Patent Application Publication
(10) Pub. No.: US 2009/0226224 A1
(43) Pub. Date: Sep. 10, 2009

(54) IMAGE FORMING APPARATUS AND TRANSFER BELT TURNING METHOD FOR IMAGE FORMING APPARATUS

(75) Inventor: Koji Takahashi, Tokyo (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/395,919

(22) Filed: Mar. 2, 2009

Related U.S. Application Data
(60) Provisional application No. 61/035,213, filed on Mar. 10, 2008.

(51) Int. Cl. G03G 15/20

(52) U.S. Cl. 399/313

(57) ABSTRACT

The surface of at least one driven roller, installed on an inner side of a transfer belt for carrying a developer in such a manner that the driven roller contacts the transfer belt, and rotating by following a turn of the transfer belt, is covered with a material having releasability containing a conductive material. The material having releasability is one or more kinds selected from silicone and fluorocarbon resin.

### CROSS-REFERENCE TO RELATED APPLICATION

This application is based upon and claims the benefit of priority from the prior U.S. Patent Application No. 61/035,213, filed on 10 Mar. 2008, the entire contents of which are incorporated herein by reference.

### TECHNICAL FIELD

The present invention relates to an image forming apparatus such as a copy machine or printer, and particularly to an image forming apparatus and a transfer belt turning method for an image forming apparatus which improve the life of a transfer belt.

### BACKGROUND

In an image forming apparatus such as a copy machine or printer, a developer such as toner is transferred from a photoconductor to a transfer belt, then transferred from the transfer belt to a recording medium, and heated and pressurized to carry out printing. The transfer belt is laid over plural rollers provided on the inner side of the transfer belt.

In a conventional image forming apparatus, a developer may be fixed to rollers over which a transfer belt is laid, and the outer diameter of the roller may change. Particularly, the developer is often fixed to a secondary transfer roller counter-driven roller facing a secondary transfer roller which transfers the developer.

FIG. 4 shows a conventional secondary transfer roller counter-driven roller 630. As shown in FIG. 4, a transfer belt 230 is laid over the secondary transfer roller counter-driven roller 630. The transfer belt 230 has regulating ribs 230A which regulate the position of the transfer belt 230, at both edges on its inner side.

The conventional driven roller is made of a metal such as aluminum, stainless steel or free-cutting steel, or an elastic resin such as EPDM (ethylene propylene rubber) or urethane. Therefore, the developer tends to be fixed thereto. Particularly, if the developer is fixed to an edge part P1, the outer diameter of the secondary transfer roller counter-driven roller 630 is increased or the belt carrying capability becomes uneven, causing the transfer belt 230 to lean in the direction of arrow X. Thus, a force is applied to a periphery P2 of the regulating ribs 230A, causing a problem that the transfer belt 230 may be cracked.

With respect to this point, for example, JP-A-2008-203729 discloses a technique of heating a transfer belt by providing a heater in order not to generate temperature inclination.

However, if the outer diameter of the secondary transfer roller counter-driven roller 630 is increased or the belt carrying capability become uneven, leaning of the transfer belt still occurs even if the belt is heated, and the problem of cracks cannot be solved.

### SUMMARY

It is an object of the invention to provide an image forming apparatus and a transfer belt turning method for an image forming apparatus which reduce fixation of a developer to a driven roller.

According to an aspect of the invention, an image forming apparatus includes: an image forming unit that forms a developer image on an image carrier; a transfer belt that carries the developer image; a transfer unit that transfers the developer image carried by the transfer belt to a recording medium; and at least one driven roller that is installed on inner side of the transfer belt and has its surface covered with a material having releasability.

### DESCRIPTION OF THE DRAWINGS

FIG. 1 is a view showing an exemplary configuration of an image forming apparatus.

FIG. 2 is a sectional view of a secondary transfer roller counter-driven roller according to an embodiment.

FIG. 3 is a view showing comparison of life of a transfer belt with the secondary transfer roller counter-driven roller according to the embodiment and with a conventional secondary transfer roller counter-driven roller.

FIG. 4 is a view showing a conventional driven roller.

### DETAILED DESCRIPTION

Throughout this description, the embodiments and examples shown should be considered as exemplars, rather than limitations on the apparatus and methods of the invention.

Hereinafter, an embodiment of an image forming apparatus and a recording medium carrying method for an image forming apparatus according to the invention will be described in detail with reference to the drawings.

### (Outline of Image Forming Apparatus)

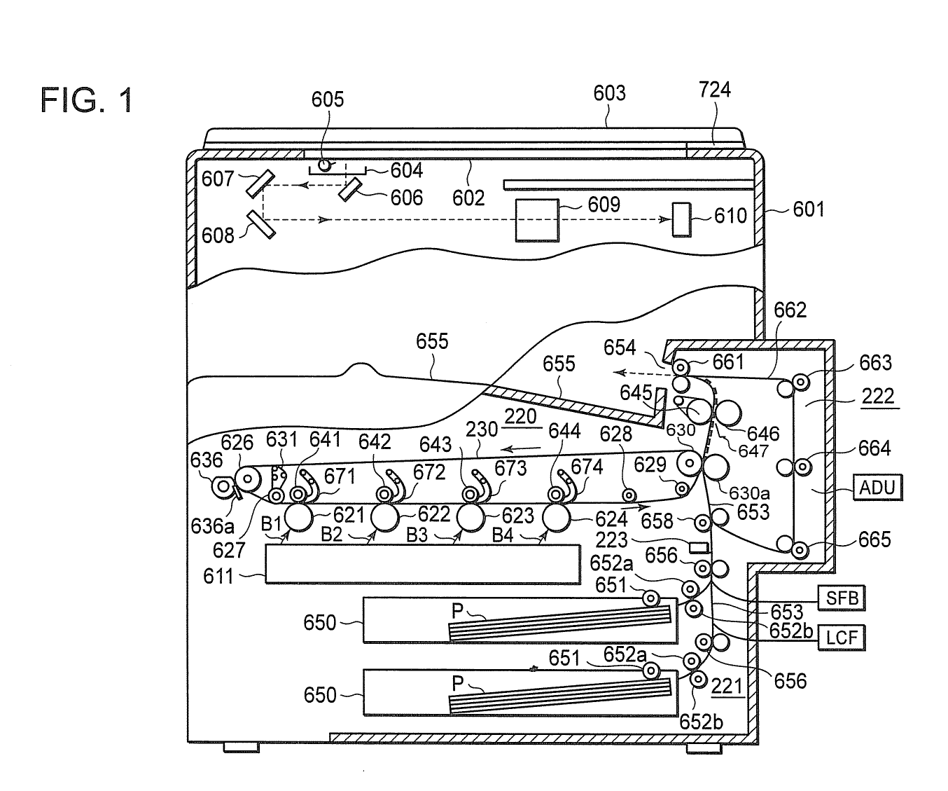

FIG. 1 shows an exemplary configuration of an image forming apparatus. As shown in FIG. 1, the image forming apparatus has a document table 602 made of a transparent material, for example, a glass plate, for setting an original on top of an apparatus body 601. The image forming apparatus also has a cover 603 to cover the document table 602 in an openable and closable manner on the apparatus body 601.

On the lower side of the document table 602 within the apparatus body 601, a scanning unit (not shown) is provided which optically scans an image of an original set on the document table 602. For example, this scanning unit has a carriage 604, reflection mirrors 606, 607 and 608 that reflect light of an exposure lamp 605 reflected by the original, a variable-power lens block 609 that varies magnification of the reflected light, and a CCD (charged coupled device) 610. The carriage 604 has the exposure lamp 605 that casts light toward the document table 602. The image forming apparatus has the carriage 604 in a manner that enables the carriage to reciprocate along the lower side of the document table 602.

The carriage 604 reciprocates while lighting the exposure lamp 605, thereby exposing light to the original set on the document table 602. The CCD 610 receives a reflection light image formed by this exposure of the original set on the document table 602, via the reflection mirrors 606, 607 and 608 and the variable-power lens block 609. The CCD 610 outputs image data corresponding to the received reflection light image of the original.

An image forming unit 220 is provided below the scanning unit within the apparatus body 601. The image forming unit 220 has, for example, a print engine (not shown) and a process unit (not shown).

The print engine includes an exposure unit 611. The process unit includes photoconductive drums 621, 622, 623 and 624 as image carriers located along the exposure unit 611, an endless transfer belt 230 situated at a position facing the exposure unit 611 with the photoconductive drums 621, 622, 623 and 624 provided between them, a drive roller 626 that drives the transfer belt 230, primary transfer rollers 641, 642, 643 and 644 situated at positions facing the photoconductive drums 621, 622, 623 and 624 with the transfer belt 230 provided between them, and a transfer roller driving unit that drives the primary transfer rollers 641, 642, 643 and 644.

In the image forming apparatus, the transfer belt 230 is laid across the drive roller 626, guide rollers 627, 628 and 629, and a secondary transfer roller counter-driven roller 630. The guide rollers 627, 628 and 629 regulate the position of the transfer belt 230. The transfer belt 230 turns counterclockwise by receiving power from the drive roller 626. The image forming apparatus has the guide roller 627 provided in such a manner that the guide roller 627 can move up and down. The guide roller 627 moves toward the transfer belt 230 by the rotation of a cam 631. The guide roller 627 displaces the transfer belt 230 toward the photoconductive drums 621, 622, 623 and 624.

This image forming unit 220 executes an image forming process to form an image based on image data (an image signal outputted from the CCD 610) and then to print the image onto a recording medium which is being carried. That is, an image signal outputted from the CCD 610 is properly processed and then supplied to the exposure unit 611. The exposure unit 611 emits a laser beam B1 corresponding to a yellow image signal to the photoconductive drum 621 for yellow, a laser beam B2 corresponding to a magenta image signal to the photoconductive drum 622 for magenta, a laser beam B3 corresponding to a cyan image signal to the photoconductive drum 623 for cyan, and a laser beam B4 corresponding to a black image signal to the photoconductive drum 624 for black.

The primary transfer rollers 641, 642, 643 and 644 move (fall) toward the transfer belt 230 and thereby bring the transfer belt 230 into contact with the photoconductive drums 621, 622, 623 and 624. Thus, visible images on the photoconductive drums 621, 622, 623 and 624 are transferred to the transfer belt 230.

The image forming apparatus has a drum cleaner, a neutralizing lamp, a charging unit and a developing unit, which are not shown, in this order in the periphery of the photoconductive drum 621. The drum cleaner has a drum cleaning blade that contacts the surface of the photoconductive drum 621, and scrapes off the remaining developer on the surface of the photoconductive drum 621 by the drum cleaning blade.

The neutralizing lamp eliminates electric charges remaining on the surface of the photoconductive drum 621. The charging unit applies a high voltage to the photoconductive drum 621 and thereby charges the surface of the photoconductive drum 621 with electrostatic charges. The exposure unit 611 irradiates the charged surface of the photoconductive drum 621 with the laser beam B1. By this irradiation, an electrostatic latent image is formed on the surface of the photoconductive drum 621. The developing unit T1 supplies a yellow developer (toner) to the surface of the photoconductive drum 621 and thereby visualizes the electrostatic latent image on the surface of the photoconductive drum 621.

As for the other photoconductive drums 622, 623 and 624, electrostatic latent images on the surface of the photoconductive drums 622, 623 and 624 are similarly visualized using the developers of the corresponding colors.

The image forming apparatus has a cleaner 636 at a position facing the drive roller 626 in the image forming unit 220, with the transfer belt 230 nipped between them. This cleaner 636 has a cleaning blade 673a that contacts the transfer belt 230, and scrapes off the remaining developer on the transfer belt 230 by the cleaning blade 673a.

The print mode can be changed as follows. The image forming apparatus has hooks 671, 672, 673 and 674 near the primary transfer rollers 641, 642, 643 and 644. These hooks 671, 672, 673 and 674 become engaged with the shafts of the primary transfer rollers 641, 642, 643 and 644 while rotating, and thus lift their shafts. The hooks 671, 672, 673 and 674 thus move the primary transfer rollers 641, 642, 643 and 644 away from the photoconductive drums 621, 622, 623 and 624. The print mode such as full-color mode, full-space mode, or monochrome mode can be changed by moving none of the primary transfer rollers 641, 642, 643 and 644, or by changing their combination when moving the primary transfer rollers 641, 642, 643 and 644.

Next, a housing mechanism and a supply mechanism for recording media will be described. The image forming apparatus has plural recording medium cassettes 650 that house recording media, below the exposure unit 611. These recording medium cassettes 650 house multiple recording media P of different recording medium types in a stacked state. The image forming apparatus has a recording medium supply mechanism 221 which supplies recording media in the recording medium cassette 650 one by one from the top, at an exit part (the right side in the drawing) of each of these recording media cassettes 650. This recording medium supply mechanism 221 takes out the recording media P one by one from one of the recording medium cassettes 650. The recording medium supply mechanism 221 for taking out the medium includes a pickup roller 651, a recording medium supply roller 652a, and a separation roller 652b. The recording medium supply mechanism 221 separates the recording media P taken out from the recording medium cassette 650, one by one, and supplies each recording medium to a recording medium carrying mechanism 653.

Next, the carrying path of the recording medium will be described. The recording medium carrying mechanism 653 extends to a recording medium discharge port 654 in an upper part via the secondary transfer roller counter-driven roller 630 of the image forming unit 220. The recording medium discharge port 654 faces a recording medium discharge unit 655 connected to the outer circumferential surface of the apparatus body 601. The image forming apparatus also has a carrying roller 656 near each recording medium supply mechanism 221, at the starting edge of the recording medium carrying mechanism 653. When one of the recording medium supply mechanisms 221 supplies a recording medium, the recording medium carrying mechanism 653 carries this recording medium to the recording medium discharge unit 655.

The image forming apparatus also has a secondary transfer roller 630a at the position facing the secondary transfer roller counter-driven roller 630 with the transfer belt 230 nipped between them, in a halfway part of the recording medium carrying mechanism 653. The image forming apparatus has a registration roller 658 at a position before the secondary transfer roller counter-driven roller 630 and the secondary transfer roller 630a in the carrying direction.

The registration roller 658 inserts the recording medium P between the transfer belt 230, which is a transfer unit, and the secondary transfer roller 630a in timing synchronized with transfer operation by the transfer belt 230 and the secondary transfer roller 630a to transfer an image formed by a developer to the recording medium. The secondary transfer roller 630a nips the recording medium P inserted from the registration roller 658 together with the transfer belt 230 on the secondary transfer roller counter-driven roller 630, transfers to the recording medium P a visible image formed by the developer and transferred to the transfer belt 230, and then prints the image. The registration roller 658 carries the recording medium P to the image forming unit 220 having the transfer belt 230 and the secondary transfer roller 630a synchronously with the transfer operation in the image forming unit 220.

The image forming apparatus has a heat fixing device for heat fixation at a position downstream from the secondary transfer roller 630a in the recording medium carrying mechanism 653. The heat fixing device has a metal roller, a fixing roller 645, a fixing belt laid across the metal roller and the fixing roller, and a pressurizing roller 646 that is abutted against the fixing roller 645 with the fixing belt provided between them. The pressurizing roller 646 has a heating device such as a heater lamp provided therein.

The heat fixing device nips the recording medium P with the developer transferred thereto between the fixing roller 645 and the pressurizing roller 646 and heats and pressurizes the recording medium P while carrying the recording medium P. At this time, the developer becomes fixed to the recording medium P. The image forming apparatus has a recording medium discharge roller 661 at the terminal end of the recording medium carrying mechanism 653.

The image forming apparatus has an entry guide 647 that guides a sheet to the nip, upstream from the fixing roller 645 and the pressurizing roller 646 in the sheet carrying direction in the heat fixing device.

The image forming apparatus may have an automatic double-side unit (hereinafter referred to as ADU) 222 in the apparatus body 601. The ADU 222 is installed to connect a sub-carrying path 662, which is a path for carrying the recording medium P in the ADU 222, to the terminal end of the recording medium carrying mechanism 653 and the entry to the registration roller 658. The sub-carrying path 662 is branched from the downstream side of the recording medium carrying mechanism 653 with respect to the image forming unit 220 (from the terminal end of the recording medium carrying mechanism 653) and merges into the upstream side of the recording medium carrying mechanism 653 with respect to the image forming unit 220 (to an upstream position from the registration roller 658).

This sub-carrying path 662 reverses the sides of the recording medium P for double-side print. The image forming apparatus has recording medium supply rollers 663, 664 and 665 in the sub-carrying path 662. The ADU 222 delivers the recording medium P which the image forming unit 220 carries to the recording medium discharge unit 655, into the opposite direction, and carries the recording medium P through the sub-carrying path 662, thus causing the recording medium to merge into the recording medium carrying mechanism 653 on the upstream side of the image forming unit 220. As the recording medium P is carried in this way, the sides of the recording medium P are reversed.

After merging the recording medium P returned to the upstream side of the image forming unit 220 by the sub-carrying path 662, into the recording medium carrying mechanism 653, the image forming apparatus sends the recording medium P by the registration roller 658 to the transfer position where the transfer belt 230 and the secondary transfer roller 630a contact each other, synchronously with the transfer operation in the image forming unit 220. Thus, the image forming apparatus transfers and thereby prints a visible image on the transfer belt 230 onto the back side of the recording medium P as well.

If double-side print is designated by an operation panel 724 provided in the apparatus body 601 or by a computer or the like connected to the apparatus body 601 via a network, the sub-carrying path 662 of the ADU 222 enters the state of actuation to reverse the sides of the recording medium P.

Next, additional devices to be provided will be described. The image forming apparatus has two recording medium cassettes 650 as recording medium supply sources. The apparatus body 601 may also have three or more recording medium cassettes 650. Moreover, though not shown, a recording medium supply mechanism for manual insertion (hereinafter referred to as SFB) or a large-capacity supply recording medium feeder (hereinafter referred to as LCF), which is a recording medium supply mechanism capable of housing thousands of recording media in a stacked state, can also be provided. The image forming apparatus may have these SFB and LCF provided in the apparatus body 601 in such a manner that their paths for supplying the recording medium merge into the recording medium carrying mechanism 653.

The image forming apparatus may also have a recording medium type sensor 223 in the apparatus body 601. The image forming apparatus has the recording medium type sensor 223 at a position that is on the upstream side of the recording medium carrying mechanism 653 with respect to the image forming unit 220 and that is upstream from the registration roller 658. The recording medium type sensor 223 detects the recording medium type of the recording medium P carried by the recording medium carrying mechanism 653. For the recording medium type sensor 223, a known sensor can be used which determines the type of the recording medium P, for example, by detecting the thickness or light transmittance of the recording medium P.

If an SFB or LCF is installed, the recording medium type sensor 223 is arranged downstream from the merging point of the recording medium supply path from the SFB or LCF and the recording medium carrying mechanism 653. With such arrangement, the type of the recording medium P carried on the recording medium carrying mechanism 653 from any of the recording medium supply sources can be detected by the single recording medium type sensor 223.

### (Driven Roller)

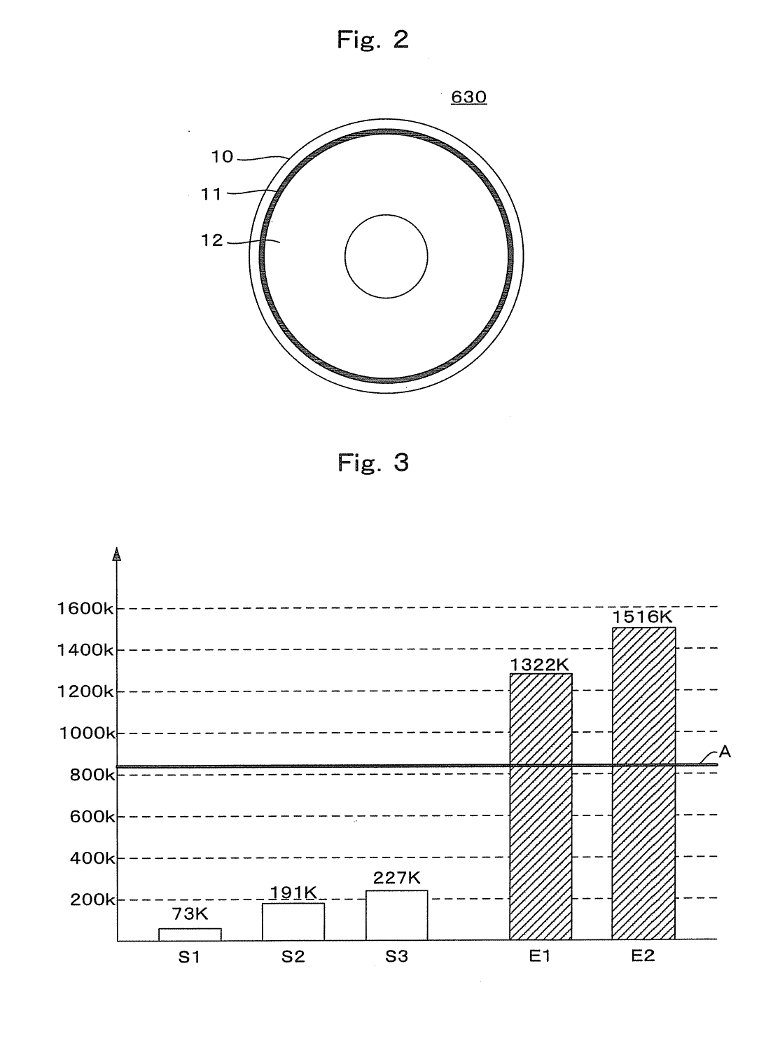

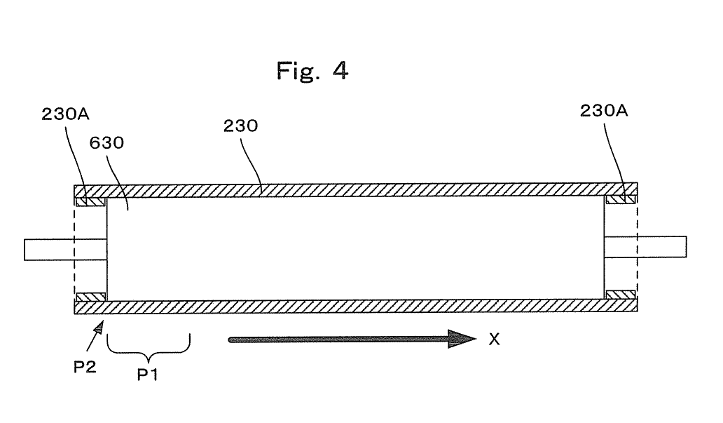

FIG. 2 is a sectional view of the secondary transfer roller counter-driven roller 630 according to this embodiment. As shown in FIG. 2, the secondary transfer roller counter-driven roller 630 has a base member 12 made of a metal such as aluminum, stainless steel or free-cutting steel, or an elastic resin such as EPDM (ethylene propylene rubber) or urethane, an adhesive layer 11 that covers the surface of the base member and attaches a material having releasability to the base member, and a material having releasability layer 10 that covers the surface of the adhesive layer 11.

For the material having releasability, at least one base material selected from silicone, that is, organosilicon compound polymers, and fluorocarbon resins including PTFE (polytetrafluoroethylene), PFA (perfluoroalkoxy polymer resin) and PVDF (poly(vinylidene fluoride)) can be used.

In the case of silicone and PTFE, a thin film is formed on an adhesive layer. In the case of PFA and PVDF, a tube is formed and this tube covers an adhesive layer. A film thickness of 10 to 30 μm is desirable and 20 μm is the most desirable.

The material having releasability is formed by dispersing a conductive material into this base material. As the conductive material, powder of a conductive substance such as carbon or copper is used. The material having releasability contains the conductive material so that its volume resistance value is 1×10⁵Ω when the base member is covered with the material having releasability.

FIG. 3 shows a comparison of life of the transfer belt 230 in the secondary transfer roller counter-driven roller 630 according to this embodiment and in a conventional secondary transfer roller counter-driven roller.

The vertical axis represents the number of sheets printed by the image forming apparatus. The letter “k” indicates×1000. Graphs S1 to S3 show the results of using the conventional secondary transfer roller counter-driven roller. As shown in FIG. 3, the transfer belt 230 breaks when approximately 73,000 to 227,000 sheets are printed.

Graphs E1 and E2 show the results of using the secondary transfer roller counter-driven roller 630 according to this embodiment. If the secondary transfer roller counter-driven roller 630 is used, the transfer belt 230 does not break until approximately 1,322,000 to 1,516,000 sheets are printed. Thus, according to this embodiment, the life of the transfer belt 230 can be extended approximately seven times.

Moreover, in this embodiment, it is possible to further extend the life of the transfer belt 230 by covering other driven rollers with a material having releasability. Here, the driven rollers covered with the material having releasability are preferably driven rollers which are situated on the inner side of the transfer belt 230, contact the transfer belt 230 and rotate by following the turn of the transfer belt 230. The driven rollers include, for example, the guide rollers 627, 628 and 629 but are not limited to these.

As described above, the driven roller according to this embodiment is covered with a material having releasability. Therefore, there is an advantage that the developer can be prevented from being fixed to the driven roller, enabling extension of the life of the transfer belt 230.

Although exemplary embodiments of the invention have been shown and described, it will be apparent to those having ordinary skills in the art that a number of changes, modifications, or alterations to the invention as described herein may be made, none of which departs from the spirit of the invention. All such changes, modifications, and alterations should therefore be seen as within the scope of the invention.

What is claimed is:

1. An image forming apparatus comprising:
an image forming unit that forms a developer image on an image carrier;
a transfer belt that carries the developer image;
a transfer unit that transfers the developer image carried by the transfer belt to a recording medium; and
at least one driven roller that is installed on inner side of the transfer belt and has its surface covered with a material having releasability.

2. The apparatus according to claim 1, wherein the driven roller is a secondary transfer roller counter-driven roller that faces a secondary transfer roller for transferring a developer to the recording medium, with the transfer belt nipped between them.

3. The apparatus according to claim 1, wherein the driven roller is a guide roller that regulates position of the transfer belt.

4. The apparatus according to claim 1, wherein the material having releasability is silicone.

5. The apparatus according to claim 1, wherein the material having releasability is a fluorocarbon resin.

6. The apparatus according to claim 5, wherein the fluorocarbon resin is one or more kinds selected from PTFE, PFA, and PVDF.

7. The apparatus according to claim 1, wherein the material having releasability contains a conductive material.

8. The apparatus according to claim 7, wherein the conductive material is one or more kinds selected from carbon and copper.

9. The apparatus according to claim 7, wherein the driven roller has a volume resistance value of 1×10⁵Ω.

10. A driven roller installed in an image forming apparatus in such a manner that, on an inner side of a transfer belt that carries a developer image formed as an image, the driven roller contacts the transfer belt, the driven roller rotating by following a turn of the transfer belt, the driven roller having its surface covered with a material having releasability.

11. The driven roller according to claim 10, wherein the driven roller is a secondary transfer roller counter-driven roller that faces a secondary transfer roller for transferring a developer to a recording medium, with the transfer belt nipped between them.

12. The driven roller according to claim 10, wherein the driven roller is a guide roller that regulates position of the transfer belt.

13. The driven roller according to claim 10, wherein the material having releasability is silicone.

14. The driven roller according to claim 10, wherein the material having releasability is a fluorocarbon resin.

15. The driven roller according to claim 14, wherein the fluorocarbon resin is one or more kinds selected from PTFE, PFA, and PVDF.

16. The driven roller according to claim 10, wherein the material having releasability contains a conductive material.

17. The driven roller according to claim 16, wherein the conductive material is one or more kinds selected from carbon and copper.

18. The driven roller according to claim 16, wherein the driven roller has a volume resistance value of 1×10⁵Ω.

19. A transfer belt turning method for an image forming apparatus comprising:
installing at least one driven roller having its surface covered with a material having releasability, on an inner side of a transfer belt for carrying a developer in the image forming apparatus in such a manner that the driven roller contacts the transfer belt, and rotating the driven roller by following a turn of the transfer belt.

20. The method according to claim 19, wherein the material having releasability is one or more kinds selected from silicone and fluorocarbon resin, containing a conductive material.
